(19) United States
(12) Patent Application Publication
(10) Pub. No.: US 2002/0138778 A1
(43) Pub. Date: Sep. 26, 2002

(54) Controlling CPU core voltage to reduce power consumption

(76) Inventors: James R. Cole, Albany, OR (US); Andrew L. Van Brocklin, Corvallis, OR (US); Chadwick W. Stryker, Albany, OR (US)

Correspondence Address: HEWLETT-PACKARD COMPANY, Intellectual Property Administration, P. O. Box 272400, Fort Collins, CO, 80527-2400, US

(21) Appl. No.: 09/815,074

(22) Filed: Mar. 22, 2001

(51) Int. Cl. G06F 1/26; G06F 1/28; G06F 1/30

(52) U.S. Cl. 713/330

(57) ABSTRACT

A CPU operating within a low power state has its core voltage controlled to be at a nominal level or a reduced level. When the CPU is active it draws power. A CPU voltage controller maintains the CPU core voltage at the nominal level to meet the fluctuating power needs of the CPU. When the power drawn from the CPU becomes constant (i.e., the CPU power needs are being met, perhaps with a ‘cushion’), the CPU voltage controller reduces the core voltage to a reduced level. The CPU core voltage remains at the reduced level until increased power needs are anticipated. One method for anticipating increased power needs is to monitor PCI bus arbitration lines.

### BACKGROUND OF THE INVENTION

This invention relates generally to methods and apparatus for reducing a processor's power consumption, and more particularly, to methods and apparatus for controlling a processor's core voltage.

For portable computers the power load requirement is continually increasing as more powerful, feature-rich systems are desired. Correspondingly, advances in processor technology are resulting in processors with increasing power needs. This invention relates to the problem of controlling power consumption in portable computers so as to extend the time between battery recharging.

One aspect of the problem is that power needs are outpacing the development of more efficient power sources. The size of the portable computer market is expected to continue increasing at a fast rate. Battery cell power capacity is not expected to increase at the same rate as the system power needs. It is expected that additional battery cells, and thus larger battery packs, will be needed to meet the power requirements of mobile computing systems. Additional cells add cost and weight to the battery pack. Increased cost is undesirable, especially for the value segment of the mobile computing market. Increased weight is undesirable for all portable computer users who have to carry around their computer system with the installed battery pack and perhaps an extra battery pack.

Thus, it is highly desirable to control CPU core power consumption in order to extend battery life when the computer operates from a battery source.

### SUMMARY OF THE INVENTION

According to an aspect of the invention, a processor operating within a low power mode has its core voltage controlled to be at a nominal level or a reduced level. When the processor is active it draws power. A CPU voltage controller maintains the CPU voltage at the nominal level to meet the fluctuating power needs of the processor or at a reduced level to conserve power.

Conventionally, the output voltage supplied to a processor is maintained at some margin above the minimum required to operate the processor. This margin is to allow for voltage ripple. Voltage ripple is caused by sudden variation in the processor current draw, such as occurs during a burst in processing activity. The change in output current draw lowers the output voltage supplied to the processor from the power supply. By responding to maintain the margin, there is assurance that the voltage level is high enough so that even during significant voltage ripples, the output voltage meets or exceeds the minimum voltage to run the processor. However, by maintaining such margin, there is an increase in the average power consumption. According to an aspect of the invention, the output voltage is maintained at lower levels so that the average power consumption can be reduced. In one embodiment, the voltage is lowered when the processor enters a sleep state. In another embodiment the output voltage is normally maintained at a lower level. In either embodiment, processor activity is anticipated and the output voltage level is raised prior to the processor activity. When the processor activity occurs increasing current draw, the output voltage already has been raised to a level to allow for the voltage ripple. One method for anticipating increased power needs is to monitor bus arbitration lines.

In one embodiment the nominal level is the default voltage level for low power mode. When the processor goes into a sleep state, the core voltage is changed to a reduced level. In another embodiment the reduced power level is the default voltage level for low power mode. When the processor needs additional power, the core voltage is increased to the nominal level.

In some embodiments the core voltage is reduced to one level for one type of sleep state and to an even lower during another ‘deeper’ (e.g., less active) sleep state.

In another embodiment the core voltage is raised to the nominal level as the processor is awakened into an active state. Following an initial surge in activity by the processor, the core voltage is reduced to conserve power, while still operating in the active state. For example a predetermined time interval elapses relative to an event, such as: triggering the processor to awaken; awakening the processor; or elevating the core voltage. The time interval is selected empirically to be sufficient to allow for the typical burst in processor activity to complete. After the time interval lapses, the output voltage is decreased.

One advantage of the invention is that the power consumption is reduced by more accurately matching the CPU core voltage to the processor power needs. Specifically, the CPU core voltage is permitted to remain at a reduced level as long as large increases in current draw to the processor are not anticipated. The invention will be better understood by reference to the following detailed description taken in conjunction with the accompanying drawings.

### BRIEF DESCRIPTION OF THE DRAWINGS

FIG. 1 is a block diagram of a portable computer system;

FIG. 2 is a diagram of a processor and core voltage regulator for reducing processor power consumption according to one embodiment;

FIG. 3 is a chart of a STPCLK# signal;

FIG. 4 is a chart of a STPCLK_A# signal;

FIG. 5 is a chart of the core voltage, Vₒᵤₜ;

FIG. 6 is a diagram of a processor and core voltage regulator for reducing processor power consumption according to another embodiment; and

FIG. 7 is a chart of signals for anticipating various levels of processing activity and a corresponding core voltage, Vₒᵤₜ, signal responsive to the anticipatory signals.

### DESCRIPTION OF SPECIFIC EMBODIMENTS

Regardless of the power source, it is desirable in any computer system to reduce power consumption. It is even more desirable in portable computer systems driven by limited power sources such as a battery source. Accordingly, portable computers are exemplary host computers which can readily take advantage of reduced power consumption benefits. Various embodiments of a portable computer include a notebook computer, sub-notebook computer, palmtop computer, hand-held computer, or another type of mobile or portable computing device. In each embodiment, the portable computer includes a processor and storage (referred to herein as a ‘microcomputer’), a display and an input mechanism.

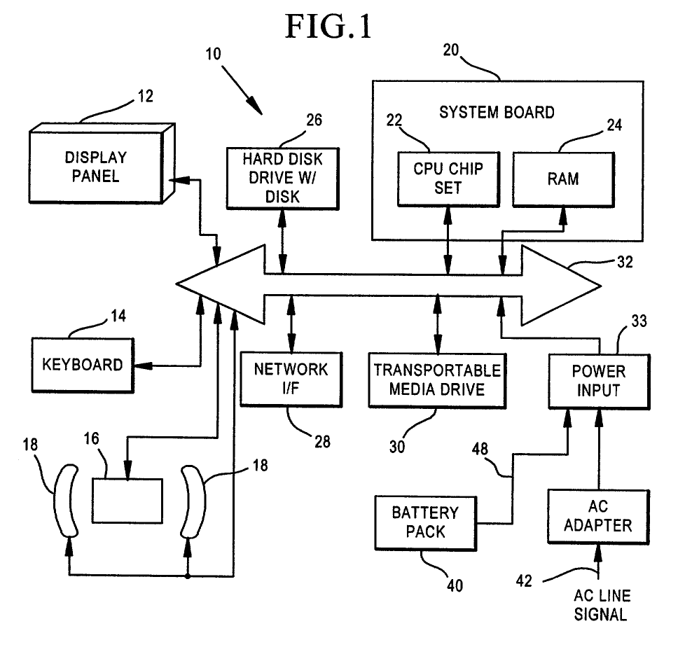

Referring to FIG. 1, an exemplary general purpose portable computer 10, such as a notebook computer includes a display panel 12, a keyboard 14, a pointing device 16, a clicking device 18, a system board 20 with a central processing unit (CPU) chip set 22 and random access memory (RAM) 24, a hard disk drive 26 with hard disk, and optionally - one or more network interfaces 28 (e.g., modem, ethernet adapter, infrared adapter), and one or more transportable storage media drives 30 and media (e.g., CD-ROM drive, DVD-ROM drive, floppy disk drive, zip drive, bernoulli drive). The various components interface and exchange data and commands through one or more busses 32. The computer system 10 receives information by entry through the keyboard 14, pointing/clicking devices 16/18, the network interface 28 or another input device or input port. The computing system 10 has a power input 33 receiving a direct current signal 48 from a battery pack 40 or a direct current signal as converted by an AC adapter from an AC line signal 42.

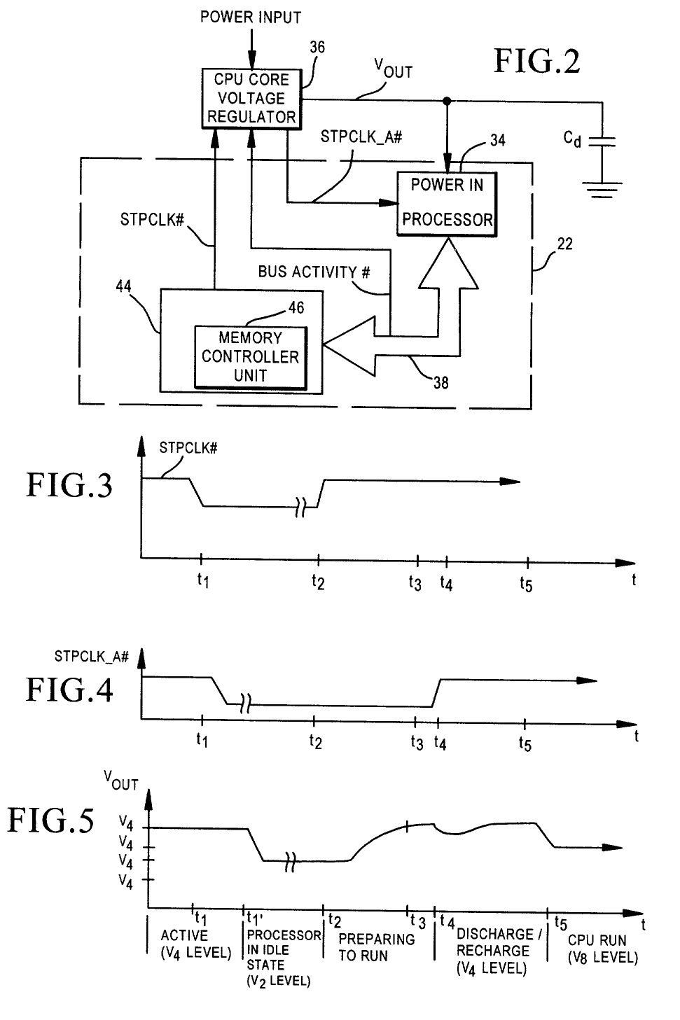

Referring to FIG. 2, a CPU chip set 22 on the system board includes a processor 34, a memory controller hub 46, and other circuits 44 interconnected by a PCI bus 38. In some embodiments the processor 34 operates in either a high speed (high power) more or a low speed (low power) mode. For example, PENTIUM™ processors often include an Intel speed step feature where the processor runs at the high speed, high power mode while powered from an AC adapter and runs at the lower speed, low power mode while powered from a battery. Note that both the clock frequency and the core voltage are altered for these two modes.

In various embodiments described herein alternative or additional features are described for running at a lower voltage to conserve power. For example, under various conditions, the processor 34 makes a decision to change from an active state of processing into a sleep state. In response to such decision, the processor 34 causes the signal STPCLK# to be asserted. In one embodiment the circuitry 44 asserts the STPCLK# signal under conditions determined by the processor 34, and in some embodiments under other conditions, (e.g., when the system is detected as being idle). When for example the PCI bus 38 activity is inactive for a prescribed time period, the circuit 44 asserts the STPCLK# signal at the voltage regulator 36. The operating system commands the processor to go into a sleep state (e.g., C2, C3) by accessing a register in circuit 44 which causes circuit 44 to assert STPCLK#.

In response to the assertion of the STPCLK# signal, the voltage regulator 36 asserts the STPCLK_A# signal to the processor 34, and reduces the core voltage Vₒᵤₜ. The processor 34 in response to the STPCLK_A# signal prepares to enter a sleep state.

The advanced configuration power interface (‘ACPI’) specification for computer systems defines specifications for various states of a computer processor. In state C₀ the processor is fully active. States C₁, C₂, C₃ are various sleep states, where C₁ is one state below fully active, and state C₃ is a fully idle mode. State C₂ is one state above C₃. The C₂ and C₃ are medium and deep sleep states where processor activity is significantly curtailed. The C₁ state is referred to as a sleep state, however, the processor is ready to resume operations without a significant latency. These states may be implemented in various ways while complying to the ACPI specification. In one embodiment the C₂ and C₃ states are implemented by having the processor finish off an instruction and flush an on-chip cache. In the C₃ state the processor 34 goes further, stopping the PCI bus 38 and gating off the clock to parts of the processor, other than critical components used for bringing the processor out of the idle state (e.g., components to allow the processor to resume).

Referring to FIG. 2, in one embodiment, whenever the processor 34 goes into a C₃ or C₂ sleep state, the CPU core voltage (Vₒᵤₜ) also is reduced to a first level (V₁) or second voltage level (V₂). The CPU chipset 22 monitors the processor 34 to determine when to change processor states (i.e., to enter one of the sleep modes). The CPU chipset 22 instructs the processor 34 to enter a sleep state by driving the STPCLK# signal to the CPU core voltage regulator 36 low. The CPU core voltage regulator 36 then reduces the core voltage to a minimum value allowed by the processor specification, plus some margin. For a C₃ sleep state the voltage is lowered to the first voltage level (VI). For a C₂ sleep state the voltage is lowered to a second voltage level (V₂). The CPU core voltage regulator 36 also gates the STPCLK_A# signal to the processor and holds it low. When STPCLK_A# is asserted the processor 34 reduces activity to enter the sleep state, then idles.

To restore the core voltage level (e.g., enter the C₀ or C₁ state) the CPU chipset 22 deasserts the STPCLK# signal to the CPU core voltage regulator 36. Because the voltage regulator 36 in turn is gating the STPCLK_A# signal low, the processor 34 does not wake up immediately. The CPU core voltage regulator 36 first responds by restoring the core voltage to a nominal value (e.g., V₄). When the core voltage (Vₒᵤₜ) is high enough, the STPCLK_A# signal to the processor 34 is deasserted. The processor then activates its processing units and other circuits, changing states to resume active operation.

Of significance is that there is a latency from the time that the CPU chipset 22 determined to activate the processor (i.e., deassert STPCLK# to voltage regulator 36) until the time that the processor 34 finally is activated (i.e., processor enters C₀ or C₁). A significant portion of the latency is due to the core voltage regulator 36 first bringing up the CPU core voltage (Vₒᵤₜ) to a high enough level for the processor to be activated. Another latency is follows the deassertion of the STPCLK_A# signal. In particular, when the processor is in a complete idle state (C₃ state), the processor 34 needs to activate the PCI bus 38 and ungate components of the processor 34. In particular, there is a delay while the internal phase locked loop (‘PLL’) of the processor 34 starts up. To reduce the overall latency when resuming from the C₃ state, the STPCLK_A# signal is deasserted at the processor before the core voltage regulator has completely raised the core voltage (Vₒᵤₜ) to the desired level (V₄). Note, however, that by the time the processor PLL settling time expires (e.g., the processor is ready to resume activity), the core voltage (Vₒᵤₜ) is at the desired level (V₄). The time interval of the latency between deassertion of the STPCLK# signal and the core voltage (Vₒᵤₜ) reaching the desired voltage level is generally known. Also, the time interval of the latency between deassertion of the STPCLK_A# signal and the processor 34 entering the C₀ or C₁ state is generally known. Accordingly, these two time intervals can be overlapped, and are overlapped in a preferred embodiment, so that the two time intervals expire at approximately the same time. Specifically, by the time the processor is in an active state, the core voltage has been sufficiently elevated to power the processor activity. Such increased voltage level is achieved either slightly before or as the processor enters an active state.

In another embodiment latency is reduced when switching from a C₂ state to an active state, by not lowering the core voltage as much when in the C₂ state as when entering the C₃ state. In the C₂ state the processor 34 latency is less, because not all components of the processor are gated off. Specifically, the PLL is not disabled. Thus, once the STPCLK_A# signal is deasserted, the processor 34 resumes faster when changing from the C₂ state to C₀ state, than when changing from the C₃ state to C₀ state. Thus, to reduce the overall latency when switching from the C₂ state, the latency at the CPU core voltage regulator 36 is reduced having less change in voltage during awakening. This is achieved by not reducing the core voltage (Vₒᵤₜ) as much for the C₂ state as for the C₃ state. With the core voltage not as low, there is less change needed to raise the core voltage to resume, and less time needed to raise the voltage.

In another embodiment, the PCI arbitration lines of the PCI bus 38 are snooped with signal BUS_ACTIVITY#. System devices such as a card bus controller, a local area network controller, a small computer serial interface (SCSI) controller or other device is able to cause PCI bus activity at their own instigation. Also, the circuit 44 monitors other busses such as an AGP bus for the display which can be activated by the display controller. When a bus (e.g., the PCI bus 38) goes active, the CPU core voltage regulator 36 detects the activity and raises the core voltage Vₒᵤₜ from the reduced first voltage level V₁ or second voltage level V₂ to voltage V₄ for the C₀ state. Also, until the PCI arbitration lines (BUS_ACTIVITY#) have been inactive for a predetermined time interval, the CPU core voltage regulator 36 is disabled from reducing the core voltage level to the first or second voltage level. Thus, to lower the core voltage to the first or second voltage level, the PCI arbitration lines are detected to be inactive for a predetermined time interval. To get a head start on bringing the processor 34 back to an active state, the core voltage is raised from the first or second voltage level after activity is detected on the PCI arbitration lines.

Power Consumption During an Active State

Referring to FIGS. 2-5, in a preferred embodiment, processor core voltage Vₒᵤₜ is lowered not just when the processor enters the C₂ or C₃ states, but also while in the C₀ or C₁ states. From an active state the circuit 44 deasserts the STPCLK# signal at time t₁. Circuit 44 is the system chip set. It includes one or more chips and circuits, including the memory hub controller 46. The chip set 44 interfaces the processor 34 to the various subsystems and busses of the computer system 10, (e.g. to memory, to a graphics processor for display, to a PCI bus for other functions, . . . ). In response the core voltage is lowered to either voltage level V₁ or V₂ depending on which sleep state is being entered. In one embodiment the processor chip set 22 includes an embedded controller which communicates with the processor, operating system circuit 44 and voltage regulator 36. The embedded controller indicates to the regulator 36 which voltage level is to be output. At some later point the processor will resume. At the time of resumption it is likely that an initial surge of processing will occur.

The first step toward bringing the processor 34 into an active state is when the CPU chipset 22 deasserts the STPCLK# signal at time t₂. In one embodiment circuit 44 detects that the system is idle and generates the signal STPCLK# to the voltage regulator 36. In another embodiment system software (e.g., operating system, utility software) determines that the system is idle and writes to a register in circuit 44 to cause the circuit 44 to generate the STPCLK# signal to the voltage regulator 36. At such time, however, the CPU core voltage regulator 36 holds off deasserting the STPCLK_A# signal at the processor 34, while the CPU core voltage Vₒᵤₜ is elevated. Eventually by time t₃, the core voltage is sufficiently elevated, and at time t₄ the STPCLK_A# signal also is deasserted at the processor 34. The latency from time t₃ to t₄ varies according to which sleep state the processor is in (and thus how long it takes to switch the processor into an active state), as previously described. As the processor 34 resumes, it has an initial surge of processing activity draining power (and causing a transient dip in Vₒᵤₜ (see FIG. 4). Eventually the transient passes and the core voltage Vₒᵤₜ stabilizes at voltage level V₄.

After a predetermined time interval following deassertion of STPCLK_A#, the core voltage at time t₅ is slightly reduced to voltage level V₃. The time interval is selected to allow the voltage regulator 36 first to compensate for the initial increased power consumption by the processor 34. In other embodiments the time interval is measured instead relative to any of: elevation of the core voltage, deassertion of STPCLK#, entry in an active state C₀ or a state C₁, or another identifiable time. Following the power transient associated with the resumption, the core voltage is slightly reduced to voltage level V₃ to conserve power.

Accordingly, power is conserved through several steps. All these steps may be implemented for either or both of the CPU high speed (high power) mode (i.e., powered by current signal derived from AC adapter) and the CPU low speed (low power) mode (i.e., powered by battery). Power is conserved in various embodiments by any or all of the following features:

1. reducing the CPU core voltage to a first level V₁ when the processor enters a deep sleep state (e.g., C₃ state);

2. reducing CPU core voltage to a second level V₂, not as low as the first level, when the processor enters a medium sleep state (e.g., C₂ state);

3. raising the CPU core voltage upon resumption to a fourth level V₄, followed by a reduction in CPU core voltage after a predetermined time interval to a third level V₃.

Note that the first level is the lowest voltage magnitude level where the greatest power consumption is achieved (i.e., the least amount of power is consumed), followed by the second level and the third level. The fourth level is the highest voltage magnitude level. The third voltage magnitude level is less than the fourth voltage magnitude level, but greater than the second voltage magnitude level.

Alternative Embodiment

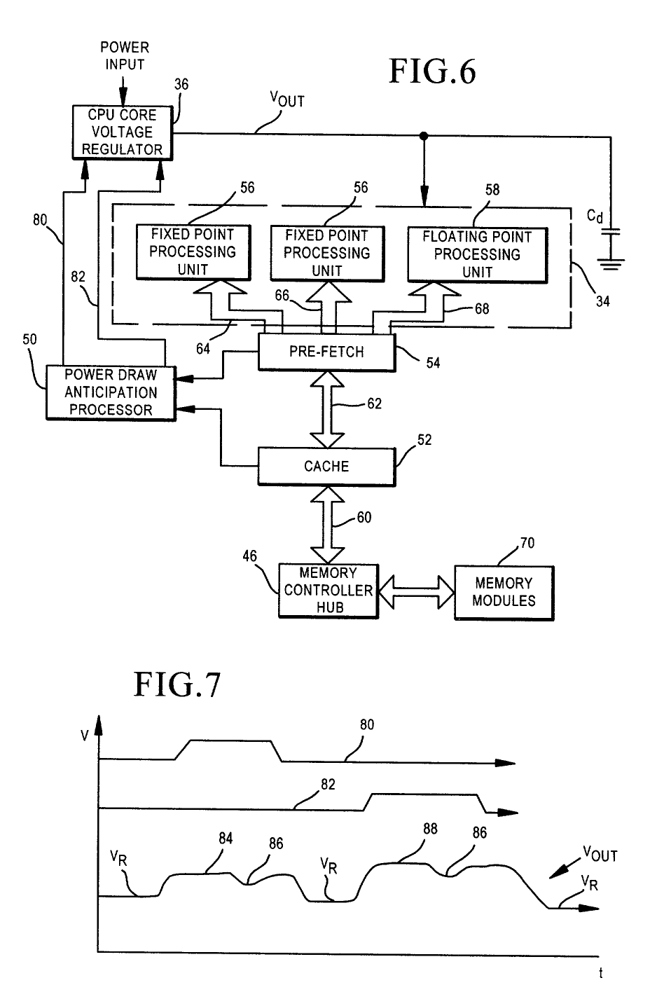

Referring to FIGS. 6 and 7, in an alternative embodiment the core voltage Vₒᵤₜ is normally maintained at a reduced level Vᵣ. A power draw anticipation processor 50 monitors the processor 34 activity to determine when a strong demand for power will ensue. In one embodiment the anticipation processor 50 monitors the cache 52 and prefetch buffer 54 for the processing units 56, 58 of the processor 34. The processor bus 38 is shown as several busses 62-68. Data is loaded into the processor cache 52 (part of on-chip RAM 24) from memory modules 70 under control of a memory controller hub 46 through bus 60.

The anticipation processor 50 monitors the cache 52 activity and the prefetch buffer 54 activity to determine when a power surge will ensue and to determine how great of a surge will ensue. In one embodiment the anticipation processor sends a signal 80 to the CPU core voltage regulator 36 when a medium surge in power is needed by processor 34. When a large surge is anticipated a signal 82 is sent instead. In response to the signal 80 or 82, the CPU core voltage regulator raises the core voltage Vₒᵤₜ. This increases the charge on discharge capacitors C_{d}. Thereafter when the CPU activity increases, a power transient occurs as the Processor 34 draws more current. This causes a discharge of the capacitors C_{d} as current is drained. As the capacitor C_{d} discharges the core voltage decreases back down to the reduced voltage level Vᵣ, where it stays until the anticipation processor 50 triggers the regulator 36 to raise the core voltage again for an anticipated power need. Signal 80 triggers the regulator 36 to raise the core voltage to one level 84. Signal 82 triggers the regulator 36 to raise the core voltage to a higher level 88. During the surge in processing activity the voltage fluctuates as a transient 86 from the sudden current drain.

In some embodiments the alternative embodiment of FIGS. 6 and 7 is combined with the embodiment of FIGS. 2-5 so that power is conserved by any or all of the following features:

1. Reducing the CPU core voltage to a first level V₁ when the processor enters a deep sleep state (e.g., C₃ state);

2. Reducing CPU core voltage to a second level V₂, not as low as the first level, when the processor enters a medium sleep state (e.g., C₂ state);

3. Raising the CPU core voltage upon resumption of an active to a fourth level V₄, followed by a reduction in CPU core voltage after a predetermined time interval to a third level V₃. The core voltage may not drop to a specific voltage level Vᵣ. There is a momentary (transient) reduction of the voltage due to the capacitors discharging. The voltage then recovers. The static reduction to Vᵣ occurs under control of the ‘anticipation’ processor. For example, a timer indicates that the transient condition is complete.)

4. While in the active state, anticipating processor activity, then elevating the core voltage from the third level V₃ to one of the nominal voltage levels 84, 86. As the capacitor C_{d} discharges, the core voltage Vₒᵤₜ decreases back down to the reduced voltage level Vᵣ, where it stays until the anticipation processor 50 triggers the regulator 36 to raise the core voltage again for an anticipated power need, or until the processor switches into a sleep state in which case the core voltage is reduced to V₁ or V₂.

Meritorious and Advantageous Effects

One advantage of the invention is that the power consumption is reduced by more accurately matching the CPU core voltage to the CPU power needs. Specifically, the CPU core voltage is permitted to remain at a reduced level as long as large increases in current draw to the CPU are not anticipated.

Although a preferred embodiment of the invention has been illustrated and described, various alternatives, modifications and equivalents may be used. Therefore, the foregoing description should not be taken as limiting the scope of the inventions which are defined by the appended claims.

What is claimed is:

1. A method for reducing power consumption of a processor within a portable computer system, comprising the steps of:
maintaining a core voltage input to a processor at a first voltage level;
anticipating processing activity prior to commencement of such processing activity; and
in response to the step of anticipating, elevating the core voltage to a desired voltage level adequate to supply power for the processing activity.

2. The method of claim 1, further comprising, prior to the step of maintaining, the steps of: reducing the core voltage to the first voltage level, and entering the processor into a sleep state, the processor receiving the core voltage at the first voltage level while the processor is in the sleep state; and further comprising, after the step of anticipating, the step of triggering the processor to enter an active state.

3. The method of claim 2, wherein there is a first latency from a first time at which elevation of the core voltage begins until a second time at which the processor enters the active state, and a second latency from a third time at which the processor is triggered until a fourth time at which the active state is achieved, and wherein the second latency occurs during the first latency.

4. The method of claim 2, in which the steps of reducing, entering, anticipating, elevating and triggering occur while the processor is operating in a low power mode.

5. The method of claim 2, further comprising the step of:
after the core voltage is elevated to the desired voltage level, reducing the core voltage to a second voltage level while the processor is in the active state.

6. The method of claim 5, wherein the core voltage is reduced to the second voltage level after a predetermined time interval following the triggering of the processor.

7. The method of claim 1, further comprising the steps of:
performing processing in an active state, while receiving the elevated core voltage;
after a predetermined time following either one of anticipating processing activity or elevating of the core voltage, reducing the core voltage to the first voltage level.

8. The method of claim 7, wherein the step of anticipating comprising anticipating a select level of processing activity and wherein the step of elevating comprises elevating the core voltage to a voltage level which is selected based upon the anticipated level of processing activity.

9. A method for reducing power consumption of a processor within a portable computer system, comprising the steps of:
entering the processor into a sleep state; and
reducing a core voltage supplied to the processor while the processor is in the sleep state;
wherein the core voltage is reduced to a first voltage level for a first sleep state and to a second voltage level for a second sleep state, magnitude of the first voltage level being lower than magnitude of the second voltage level and the first sleep being more inactive than the second sleep state.

10. The method of claim 9, further comprising the steps of:
anticipating processing activity prior to commencement of such processing activity;
in response to the step of anticipating, elevating the core voltage to a desired voltage level adequate to supply power for the processing activity.

11. The method of claim 10, further comprising the step of:
after the core voltage is elevated to the desired voltage level, reducing the core voltage to a third voltage level while the processor is in the active state.

12. The method of claim 11, further comprising the step of:
after the step of anticipating, triggering the processor to enter into an active state;
wherein the core voltage is reduced to the second voltage level after a predetermined time interval following the triggering of the processor.

13. The method of claim 11, in which the steps of entering, reducing to a first voltage level or second voltage level, anticipating, elevating, reducing to a third voltage level, and triggering occur while the processor is operating in a low power mode.

14. A method for reducing power consumption of a processor within a portable computer system, comprising the steps of:
entering the processor into a sleep state; and
reducing a core voltage supplied to the processor while the processor is in the sleep state;
prior to resuming processing activity, elevating the core voltage to a desired voltage level wherein there is a first latency from a first time at which elevation of the core voltage begins until a second time at which processing activity resumes;
while the core voltage is being elevated, commencing a change in state of the processor to resume processing activity, wherein there is second latency from a third at which the change of state is commencing until a fourth time at which the change of state is achieved, and wherein the second latency occurs during the first latency.

15. The method of claim 14, further comprising the step of:
anticipating processing activity prior to commencement of such processing activity;
wherein the step of elevating occurs in response to the step of anticipating.

16. A computer system, comprising:
a voltage regulator receiving a power input and regulating a core voltage as an output;
a processor powered by the core voltage and operable in an active state and a sleep state;
wherein the voltage regulator regulates the core voltage during a low power mode to be one of either a reduced voltage level or a nominal voltage level.

17. The system of claim 16, further comprising
means for anticipating processor activity; and wherein the voltage regulator normally maintains the voltage level at the reduced voltage level and raises the voltage level to the nominal voltage level when processing activity is anticipated.

18. The system of claim 17, in which the anticipating means determines an anticipated level of processing activity and wherein the voltage regulator determines the nominal voltage level according to the anticipated amount of processing activity.

19. The system of claim 16, in which the processor runs in any of a plurality of states comprising a first sleep state, a second sleep state and an active state, wherein the processor is least active during the first sleep state;
wherein the voltage regulator regulates the reduced voltage level to be a first voltage level during the first sleep state and to be a second voltage level during a second sleep state, magnitude of the first voltage level being less than magnitude of the second voltage level.

20. The system of claim 19, further comprising:
means for anticipating processing activity prior to commencement of such processing activity while the processor is in either one of the first sleep state or the second sleep state; and
wherein the voltage regulator in response to the anticipating means elevates the core voltage to the nominal voltage level and triggers the processor to enter the active state.

21. The system of claim 20, wherein there is a first latency from a first time at which the voltage regulator begins to elevate the core voltage begins until a second time at which the processor enters the active state, and a second latency from a third time at which the processor is triggered until a fourth time at which the active state is achieved, and wherein the second latency occurs during the first latency.

22. The system of claim 20, wherein the voltage regulator reduces the nominal voltage after a predetermined time interval following the triggering of the processor, the processor continuing to process in the active mode while receiving the reduced nominal voltage.
